(19) United States
(12) Patent Application Publication
(10) Pub. No.: US 2013/0261932 A1
(43) Pub. Date: Oct. 3, 2013

(54) CONTROL SYSTEM FOR HYBRID VEHICLE

(71) Applicant: DENSO CORPORATION, Kariya-city (JP)

(72) Inventor: Tsuyoshi OKAMOTO, Kariya-city (JP)

(73) Assignee: DENSO CORPORATION, Kariya-city (JP)

(21) Appl. No.: 13/850,743

(22) Filed: Mar. 26, 2013

(30) Foreign Application Priority Data
Mar. 29, 2012 (JP) 2012-75611

(51) Int. Cl. F02D 45/00

(52) U.S. Cl. CPC F02D 45/00
USPC 701/102

(57) ABSTRACT

A warm-up control unit determines that a fuel-consumption improving effect cannot be obtained or it is not necessary to facilitate a warm-up operation of an engine, when a manual switch, for example, an ECO-switch, is turned on, when an accelerator opening degree is smaller than a predetermined degree and a variation of the accelerator opening degree for a unit time is smaller than a predetermined variation value, or when an ambient temperature is lower than a predetermined temperature and there is no demand for a heating operation. Then, the warm-up control unit lowers a priority for preferentially carrying out the warm-up operation of the engine, so that an adverse effect for improving fuel consumption ratio which may be caused by facilitating the warm-up operation can be avoided.

### CROSS REFERENCE TO RELATED APPLICATION

This application is based on Japanese Patent Application No. 2012-075611 filed on Mar. 29, 2012, the disclosure of which is incorporated herein by reference.

### FIELD OF TECHNOLOGY

The present disclosure relates to a control system for a hybrid vehicle having an engine and a motor-generator as a driving source for the hybrid vehicle.

### BACKGROUND

In recent years, the hybrid vehicles having the engine and the motor-generator (hereinafter, the MG) as the driving source for the vehicle come under the spotlight in view of social request for low fuel consumption and low emission of harmful components in exhaust gas. In one of the hybrid vehicles, an engine is controlled with a process for facilitating a warm-up operation of the engine, for example, a process for increasing a rotational speed of the engine, a process for retarding ignition timing, a process for increasing output of the engine and so on, when starting the engine in a cold circumstance and when temperature of the engine is low (for example, temperature of engine cooling water is lower than a predetermined value). The temperature of the engine is quickly and promptly increased by such engine control, so as to quickly achieve combustion stability and to quickly decrease friction loss to thereby improve fuel consumption ratio.

However, in the above engine control, an increased amount of fuel (a demerit) for the process of facilitating the warm-up operation of the engine may become larger than an improved amount of the fuel (a merit) obtained as a result of facilitating the warm-up operation, depending on a vehicle driving pattern. In such a case, the process for facilitating the warm-up operation of the engine may adversely reduce the fuel consumption ratio.

A technology for suppressing decrease of the fuel consumption ratio due to the warm-up operation of the engine is known in the art, for example, as disclosed in Japanese Patent Publication No. 2006-291729, according to which an engine operating condition is estimated based on information from a car navigation system and/or learning information of past vehicle driving patterns of a vehicle driver. When it is estimated that a driving load for a vehicle becomes such a value larger than a predetermined value, a process of increasing output of an engine is not carried out for facilitating the warm-up operation of the engine.

According to the above engine control (JP No. 2006-291729), since it is necessary to use the information from the car navigation system and/or the learning information of the past vehicle driving patterns of the vehicle driver, the above technology cannot be applied to such a vehicle having no navigation system or when the navigation system is not used by the vehicle driver (for example, a target place is not preset). In addition, it is not possible for the above engine control to sufficiently suppress the decrease of the fuel consumption ratio due to the process of facilitating the warm-up operation of the engine, when the vehicle driver is changed.

### SUMMARY OF THE DISCLOSURE

The present disclosure is made in view of the above problem. It is an object of the present disclosure to provide a control system for a hybrid vehicle, according to which decrease of fuel consumption ratio due to a warm-up operation of an engine can be effectively suppressed.

According to a feature of the present disclosure, a control system is applied to a hybrid vehicle, which has an engine and a motor-generator as a driving source for driving the vehicle. A warm-up control unit is provided for controlling a facilitated warm-up operation of the engine when temperature of the engine is low. The warm-up control unit changes priority for preferentially carrying out the warm-up operation of the engine in accordance with a predetermined outside request.

According to the above feature, when the warm-up control unit determines that fuel-consumption improving effect cannot be obtained even when the warm-up operation is facilitated (for example, fuel amount necessary for the warm-up operation becomes larger than fuel amount to be saved due to the facilitated warm-up operation) or when the warm-up control unit determines that it is not necessary to facilitate the warm-up operation, the warm-up control unit lowers the priority for preferentially carrying out the warm-up operation of the engine. As a result, an adverse effect for improving the fuel consumption ratio, which may be caused by the facilitated warm-up operation, can be avoided.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view showing a control system for a hybrid vehicle according to an embodiment of the present disclosure;

FIG. 2 is a flowchart showing a routine for controlling a warm-up operation of an engine; and

FIG. 3 is a graph showing operating points for a normal control, a control for facilitating the warm-up operation and a preferential control for a motor-generator.

### DETAILED DESCRIPTION OF THE EMBODIMENTS

A control system according to an embodiment of the present disclosure will be explained.

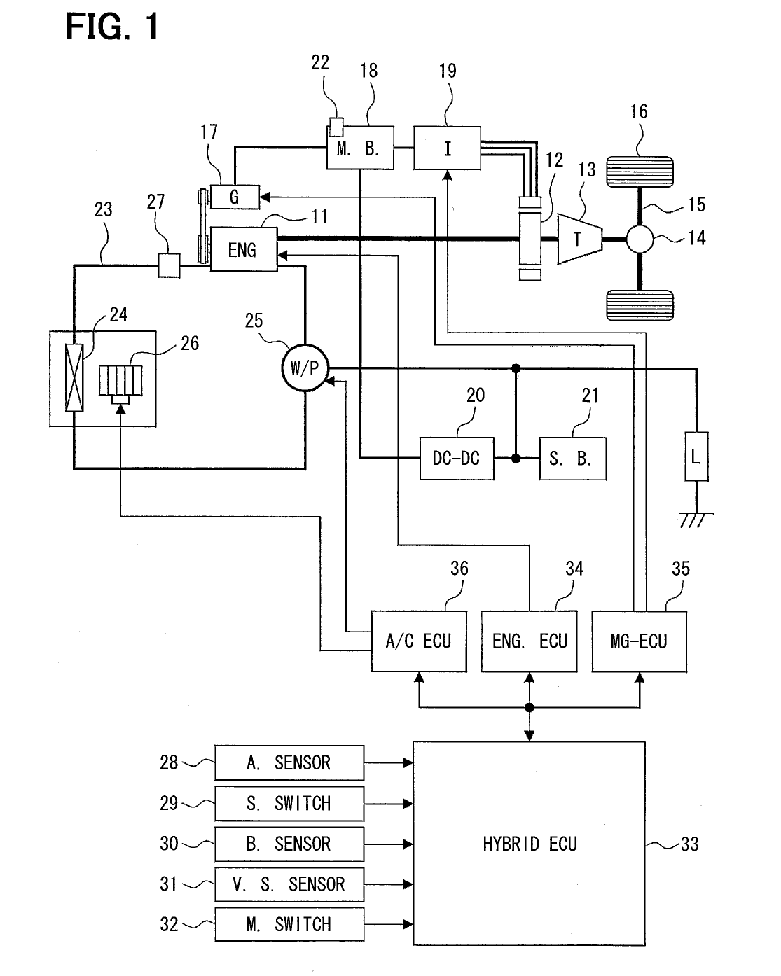

An outlined structure of the control system for a hybrid vehicle (hereinafter, the vehicle) will be explained with reference to FIG. 1. An internal combustion engine 11 (hereinafter, the engine 11) and a motor-generator 12 (hereinafter, the MG 12) are mounted in the vehicle as a driving source thereof. A driving force of an output shaft (that is, a crankshaft) of the engine 11 is transmitted to a transmission apparatus 13 via the MG 12. Then, a driving force of an output shaft of the transmission apparatus 13 is transmitted to wheels 16 via a differential gear 14 and a drive shaft 15. The transmission apparatus 13 may be composed of a multi-step transmission device for changing gears in a stepwise manner or a step-less transmission device for changing gears (for changing speed) in a step-less manner.

A rotational shaft of the MG 12 is provided in a driving power transmitting path for transmitting the driving force of the engine 11 to the wheels 16, more exactly between the engine 11 and the transmission apparatus 13, so that a driving force of the MG 12 can be also transmitted to the wheels 16, or vice versa. A clutch (not shown) may be provided between the engine 11 and the MG 12 or between the MG 12 and the transmission apparatus 13.

An electric power generator 17 (hereinafter, the generator 17) is driven by the engine 11 and electric power generated by the generator 17 is charged into a main battery 18. An inverter 19 for operating the MG 12 is connected to the main battery 18, so that the MG 12 gives and receives electric power to and from the main battery 18 via the inverter 19. In addition, the main battery 18 gives and receives electric power to and from a sub-battery 21 via a DC-DC converter 20. A battery temperature sensor 22 is provided in the main battery 18 for detecting temperature of the main battery 18.

A hot water circuit 23 for a heating operation is provided in a cooling-water circuit (not shown) for the engine 11. A heater core 24 and an electric water pump 25 are provided in the hot water circuit 23 for the heating operation. The electric water pump 25 is driven by the electric power from the sub-battery 21 so as to circulate engine cooling water (hot water) between the engine 11 and the heater core 24. A blower fan 26 is provided at a position adjacent to the heater core 24 to generate hot air. A cooling-water temperature sensor 27 is provided in the hot water circuit 23 for detecting temperature of the engine cooling water (temperature of the hot water).

An accelerator opening degree (that is, an operating stroke of an acceleration pedal) is detected by an acceleration sensor 28. A shift position (that is, an operated position of a shift lever) is detected by a shift switch 29. A brake operation is detected by a brake switch 30. A vehicle speed is detected by a vehicle speed sensor 31. A manual switch 32 is provided at a position adjacent to a vehicle driver's seat, so that the manual switch 32 is operated by the vehicle driver. For example, the manual switch 32 can be commonly used with an ECO-switch for switching to an “ECO-mode” operation (an engine operational mode for giving priority to fuel consumption ratio). The manual switch 32 can be, alternatively, a canceling switch independently provided for canceling a process of facilitating the warm-up operation, to thereby change (raise or lower) a priority for facilitating the warm-up operation. The manual switch 32 is also referred to as a warm-up control switch 32.

A hybrid ECU 33 is a computer for totally controlling vehicle operating condition. The hybrid ECU 33 reads output signals from the above sensors and switches in order to detect the vehicle operating condition. The hybrid ECU 33 communicates with an engine ECU 34 for controlling an engine operating condition, an MG-ECU 35 for controlling the inverter 19 to operate the MG 12 and controlling the generator 17, and an air-conditioner ECU 36 (hereinafter, the A/C ECU 36) for controlling a heating device (including the electric water pump 25, the blower fan 26 and so on), in order to transmit and/or receive control signals as well as data signals among those ECUs 33 to 36. As a result, the engine ECU 34, the MG-ECU 35 and the A/C ECU 36 control, depending on the detected vehicle operating condition, the engine 11, the MG 12, the generator 17, the heating device (the electric water pump 25 and the blower fan 26) and so on.

For example, when the engine 11 in a low temperature condition after start-up of the engine 11 in a cold circumstance (for example, when the cooling-water temperature is lower than a predetermined value (the predetermined temperature)), the hybrid ECU 33 carries out a control for facilitating the warm-up operation of the engine 11, such as, a control for increasing engine rotational speed, a control for retarding ignition timing, a control for increasing output of the engine, and so on. The hybrid ECU 33 quickly increases engine temperature (the temperature of the engine 11) by the above control for facilitating the warm-up operation of the engine 11, in order to quickly achieve combustion stability and quickly decrease friction loss so that fuel consumption ratio is improved.

However, in the above engine control, an increased amount of fuel (a demerit) for the control of facilitating the warm-up operation of the engine may become larger than an improved amount of the fuel (a merit) obtained as a result of facilitating the warm-up operation, depending on a vehicle driving pattern. In such a case, the control for facilitating the warm-up operation of the engine may adversely reduce the fuel consumption ratio.

For example, in a case of a long-distance vehicle driving, when the warm-up operation of the engine 11 is facilitated so as to quickly warm-up the engine 11, an amount of the fuel to be saved as a result of a fuel-consumption improving effect (such as, an effect obtained by achieving the combustion stability and decreasing the friction loss in a shorter period) can be made larger than an amount of the fuel to be consumed for facilitating the warm-up operation. However, in case of a short-distance vehicle driving, most of energy used for facilitating the warm-up operation of the engine is radiated to the air after the vehicle is stopped and thereby such energy may not be effectively used for improving the fuel consumption ratio.

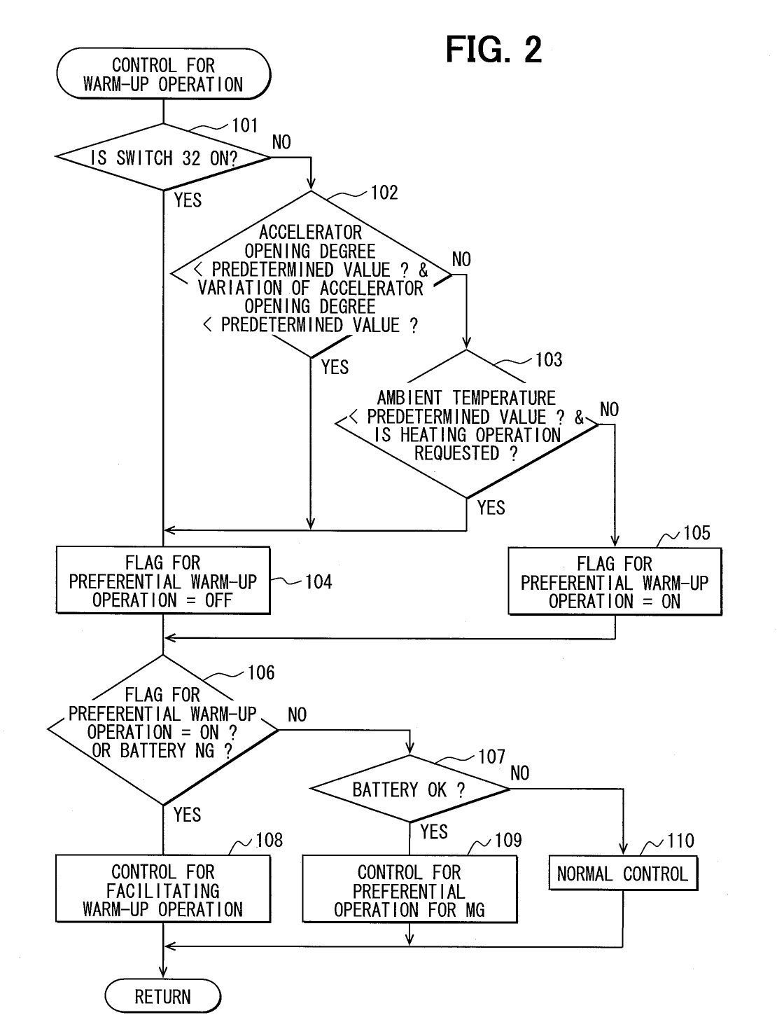

According to the present embodiment, a routing for controlling the warm-up operation (explained below with reference to FIG. 2) is carried out by the hybrid ECU 33, so that a priority for facilitating the warm-up operation of the engine 11 is changed depending on predetermined outside request(s). When the hybrid ECU 33 determines based on the predetermined outside request that the fuel-consumption improving effect cannot be obtained even when the warm-up of the engine 11 is facilitated (namely, when the amount of the fuel to be increased for facilitating the warm-up operation of the engine 11 becomes larger than the improved amount of the fuel to be saved by facilitating the warm-up of the engine 11), or when the hybrid ECU 33 determines that it is not necessary to facilitate the warm-up operation of the engine 11, the priority for facilitating the warm-up operation of the engine 11 is lowered. Accordingly, an adverse effect for the fuel consumption, which may be caused by the process for facilitating the warm-up operation of the engine 11, can be avoided.

According to the present embodiment, an operation of the manual switch 32 is monitored as one of the outside requests, so that the priority for facilitating the warm-up operation of the engine 11 is changed depending on the operation of the manual switch 32. According to such a structure and operation, when the manual switch 32 is turned on (for example, the ECO-switch or the canceling switch is turned on), the hybrid ECU 33 determines that the fuel-consumption improving effect cannot be obtained even when the warm-up of the engine 11 is facilitated or that it is not necessary to facilitate the warm-up of the engine 11, the hybrid ECU 33 lowers the priority for the process of facilitating the warm-up operation of the engine 11. As a result, the adverse effect for the fuel consumption, which may be caused by the process for facilitating the warm-up operation of the engine 11, can be avoided.

In addition, according to the present embodiment, the accelerator opening degree of the acceleration pedal is monitored as another one of the outside requests. When the accelerator opening degree is smaller than a predetermined value (the predetermined degree) and when a variation of the accelerator opening degree for a unit time is smaller than a predetermined value (the predetermined variation value), the priority for facilitating the warm-up operation of the engine 11 is lowered. The above situation (the accelerator opening degree and the variation thereof for the unit time are respectively smaller than the predetermined values) corresponds to a vehicle driving condition in which the vehicle is running at a low speed and with a low load. In such a case, a burden ratio of the engine 11 (that is, a ratio of the driving force necessary for the vehicle running and shouldered by the engine) can be made smaller or the engine operation itself can be stopped. Accordingly, the hybrid ECU 33 determines that it is not necessary to facilitate the warm-up operation of the engine 11 and lowers the priority for facilitating the warm-up operation. As a result, the adverse effect for the fuel consumption, which may be caused by the process for facilitating the warm-up operation of the engine 11, can be avoided.

Furthermore, according to the present embodiment, a demand for the heating operation is monitored as a further one of the outside requests. Namely, when the ambient temperature is lower than a predetermined value (the predetermined temperature) but there is no demand for the heating operation by the heating device (the heater core 24 and the blower fan 26), the priority for facilitating the warm-up operation of the engine 11 is lowered. In this situation, it is not necessary to quickly increase the temperature of the cooling water circulating in the hot-water circuit 23. Therefore, the hybrid ECU 33 determines that it is not necessary to facilitate the warm-up operation of the engine 11 or determines that the fuel-consumption improving effect cannot be obtained even when the warm-up operation of the engine 11 is facilitated because of the short-distance vehicle running. Then, the hybrid ECU 33 lowers the priority for facilitating the warm-up operation. As a result, the adverse effect for the fuel consumption, which may be caused by the process for facilitating the warm-up operation of the engine 11, can be avoided.

Furthermore, according to the present embodiment, when a remaining amount of electric power charged in the battery (the remaining amount of the main battery 18) is larger than a predetermined value (the predetermined battery amount) and temperature of the battery (the temperature of the main battery 18) is higher than a predetermined value (the predetermined battery temperature), a burden ratio of the MG 12 (that is, a ratio of the driving force necessary for the vehicle running and shouldered by the MG) is made larger than that in a normal situation. In the above situation, the hybrid ECU 33 determines that the main battery 18 has the luxury of the remaining amount and the main battery 18 can output sufficient electric power at such high battery temperature. Then, the hybrid ECU 33 makes the burden ratio of the MG 12 larger than that in the normal situation. In other words, the hybrid ECU 33 makes the burden ratio of the engine 11 smaller than that in the normal situation. As a result, an amount of the fuel consumed by the engine 11 can be reduced, to thereby decrease cooling loss (energy used for the warm-up operation).

As already explained above, in the case of the short-distance vehicle driving, most of energy used for facilitating the warm-up operation of the engine may be radiated to the air after the vehicle is stopped and thereby such energy may not be effectively used for improving the fuel consumption ratio. Therefore, when the burden ratio of the MG 12 is made larger than that in the normal situation and thereby the burden ratio of the engine 11 is made smaller than that in the normal situation, it becomes possible to reduce the energy to be used for the warm-up operation.

In addition, according to the present embodiment, when the remaining amount of the battery is smaller than the predetermined battery amount or when the temperature of the battery is lower than the predetermined battery temperature, the control for facilitating the warm-up operation of the engine 11 is preferentially carried out. Since, in this situation, the battery does not have the luxury of the remaining amount or the battery cannot sufficiently output the electric power at such low battery temperature, the hybrid ECU 33 determines that the output of the MG 12 cannot be made larger even when the hybrid ECU 33 receives a demand for the vehicle driving with a high load. Therefore, the hybrid ECU 33 preferentially carries out the control for facilitating the warm-up operation of the engine 11, so that the output of the engine 11 can be increased when the demand for the vehicle driving with the high load is generated.

The above explained control for the warm-up operation can be carried out by the hybrid ECU 33 in accordance with a routine shown in FIG. 2. The routine for controlling the warm-up operation will be explained hereinafter.

As shown in FIG. 2, the routine for controlling the warm-up operation is repeatedly carried out for a predetermined cycle during a period in which the electric power supply to the hybrid ECU 33 is turned on. The hybrid ECU 33 is also referred to as a warm-up control unit.

When the routine is activated, the hybrid ECU 33 (the warm-up control unit 33) determines at a step 101 whether the manual switch 32 (for example, the ECO-switch, the canceling switch or the like) is turned on by the vehicle driver or not.

When the hybrid ECU 33 determines at the step 101 that the manual switch 32 is turned on (YES at the step 101), the hybrid ECU 33 deems that the fuel-consumption improving effect cannot be obtained even when the warm-up operation for the engine 11 is facilitated or deems that it is not necessary to carry out the warm-up operation for the engine 11. Then, the process goes to a step 104, at which a flag for preferentially carrying out the warm-up operation is reset (turned to OFF), so that the priority for facilitating the warm-up operation is lowered. As a result, an adverse effect for the fuel consumption ratio, which may be caused by the process for facilitating the warm-up operation of the engine 11, can be avoided.

On the other hand, when the hybrid ECU 33 determines at the step 101 that the manual switch 32 is not turned on (NO at the step 101), the process goes to a step 102. The hybrid ECU 33 determines at the step 102 whether the accelerator opening degree is smaller than the predetermined value (the predetermined degree) and whether the variation of the accelerator opening degree for the unit time is smaller than the predetermined value (the predetermined variation value).

When the hybrid ECU 33 determines at the step 102 that the accelerator opening degree is smaller than the predetermined value and that the variation of the accelerator opening degree for the unit time is smaller than the predetermined value (YES at the step 102), the hybrid ECU 33 deems that the vehicle is running at the low speed and with the low load. In such a situation, the burden ratio of the engine 11 can be made smaller or the engine operation itself can be stopped. Therefore, the hybrid ECU 33 determines that it is not necessary to facilitate the warm-up operation of the engine 11. Therefore, the process goes to the step 104 so as to reset the flag for preferentially carrying out the warm-up operation to a turned-off condition (OFF), so that the priority for facilitating the warm-up operation is lowered. As above, the adverse effect for the fuel consumption ratio, which may be caused by the process for facilitating the warm-up operation of the engine 11, can be avoided.

On the other hand, when the hybrid ECU 33 determines at the step 102 that the accelerator opening degree is larger than the predetermined value (the predetermined degree) or that the variation of the accelerator opening degree for the unit time is larger than the predetermined value (the predetermined variation value), namely NO at the step 102, the process goes to a step 103 in order to determine whether the ambient temperature is lower than a predetermined value (the predetermined temperature) and whether the demand for the heating operation is OFF (for example, whether a switch for the blower fan 26 is turned off or not).

When the hybrid ECU 33 determines at the step 103 that the ambient temperature is lower than the predetermined value and that the demand for the heating operation is OFF (namely, when the ambient temperature is low but there is no demand for the heating operation) (YES at the step 103), it is not necessary to quickly increase the temperature of the engine cooling water circulating in the hot water circuit 23. Therefore, the hybrid ECU 33 deems that it is not necessary to facilitate the warm-up operation of the engine 11 or deems that the fuel-consumption improving effect cannot be obtained because of the short distance vehicle driving. The process, therefore, goes to the step 104 so as to reset the flag for preferentially carrying out the warm-up operation to the turned-off condition (OFF), so that the priority for facilitating the warm-up operation is lowered. Accordingly, the adverse effect for the fuel consumption ratio, which may be caused by the process for facilitating the warm-up operation of the engine 11, can be avoided.

On the other hand, when the determinations at the steps 101, 102 and 103 are all NO, the hybrid ECU 33 deems that it is not necessary to lower the priority for facilitating the warm-up operation of the engine 11. Therefore, the process goes to a step 105, at which the flag for preferentially carrying out the warm-up operation is turned ON.

Then, the process goes to a step 106, at which the hybrid ECU 33 determines whether the flag for preferentially carrying out the warm-up operation is turned ON or whether the main battery 18 is in a not-good (NG) condition or not. The determination whether the main battery 18 is in the NG condition or not is done by a determination whether the remaining amount of the main battery 18 is smaller than the predetermined value (the predetermined battery amount) or a determination whether the temperature of the main battery 18 is lower than the predetermined value (the predetermined battery temperature).

When the hybrid ECU 33 determines at the step 106 that the flag for preferentially carrying out the warm-up operation is turned ON (YES at the step 106), the process goes to a step 108 so as to carry out the control for facilitating the warm-up operation of the engine 11. Even when the flag for preferentially carrying out the warm-up operation is turned OFF, the process goes to the step 108 when the hybrid ECU 33 determines that the main battery 18 is in the NG condition (YES at the step 106). This is because the hybrid ECU 33 deems that the main battery 18 does not have the luxury of the remaining amount or that the main battery 18 cannot output sufficient electric power at the low battery temperature. Furthermore, the hybrid ECU 33 deems that the burden ratio of the MG 12 cannot be made larger even when a demand for the vehicle driving with the high load is generated. Therefore, the process goes to the step 108 in order to carry out the control for facilitating the warm-up operation. It becomes possible to cope with such a situation, in which the demand for the vehicle driving with the high load is generated, by increasing the output of the engine 11.

In the control for facilitating the warm-up operation of the engine 11 (at the step 108), at least one of the following controls is carried out when the engine 11 is in the low temperature condition (for example, when the cooling-water temperature is lower than the predetermined value);
the control for increasing engine rotational speed;
the control for retarding ignition timing; and
the control for increasing output of the engine.

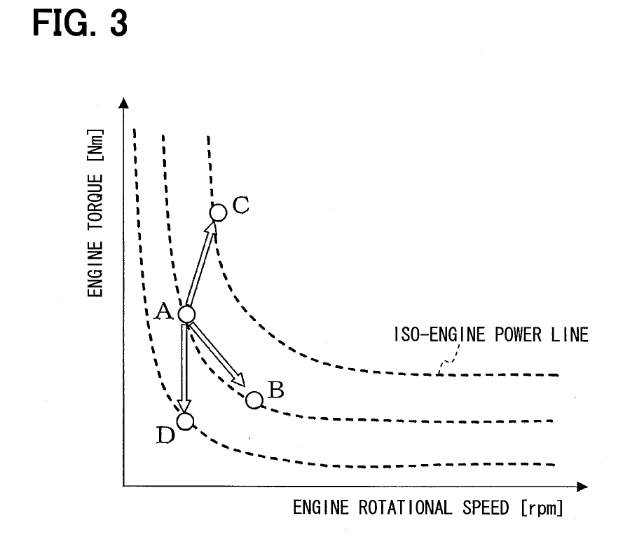

As shown in FIG. 3, when the control for increasing the engine rotational speed is carried out, an operating point of the engine 11 is changed from an operating point A for the normal operation to an operating point B for increasing the engine rotational speed. According to such control, not only an amount of fuel consumption at the operating point A is increased to an amount of fuel consumption at the operating point B, but also the cooling loss (the energy used for the warm-up operation) at the operating point A is increased to the cooling loss at the operating point B, so that the warm-up operation of the engine 11 is facilitated.

When the control for increasing the output of the engine is carried out, the operating point of the engine 11 is changed from the operating point A for the normal operation to an operating point C for increasing the output of the engine. As a result, the amount of the fuel consumption at the operating point A is increased to that at the operating point C on one hand, the cooling loss at the operating point A is increased to that at the operating point C on the other hand. Therefore, the warm-up operation of the engine 11 is facilitated.

When the hybrid ECU 33 determines at the step 106 that the flag for preferentially carrying out the warm-up operation is turned OFF and that the main battery 18 is not in the NG condition (NO at the step 106), the process goes to a step 107. The determination whether the main battery 18 is in a good condition (the OK condition) or not is done by a determination that the remaining amount of the main battery is larger than the predetermined value (the predetermined battery amount) and a determination that the temperature of the main battery is higher than the predetermined value (the predetermined battery temperature).

When the hybrid ECU 33 determines at the step 107 that the main battery 18 is in the OK condition (YES at the step 107), the hybrid ECU 33 deems that the main battery 18 has the luxury of the remaining amount and the main battery 18 can output sufficient electric power at the high battery temperature. Then, the process goes to a step 109, at which the control for preferentially operating the MG 12 (the preferential control for the MG 12) is carried out. In the preferential control for the MG 12, the burden ratio of the MG 12 is made to be larger than that in the normal situation, while the burden ratio of the engine 11 is made to be smaller than that in the normal situation. In this situation, as shown in FIG. 3, the operating point of the engine 11 is changed from the operating point A for the normal operation to an operating point D for the preferential control for the MG 12. As a result, the amount of the fuel consumption at the operating point A is decreased to that at the operating point D, while the cooling loss at the operating point A is decreased to that at the operating point D.

When the hybrid ECU 33 determines at the step 107 that the main battery 18 is not in the OK condition (NO at the step 107), the process goes to a step 110 so as to carry out the normal control. In the normal control, the engine 11 is operated in accordance with a demand for power generation, which is decided based on the vehicle driving condition, the condition of the main battery 18 and so on. In other words, the engine 11 is operated not for the purpose of facilitating the warm-up operation but for purpose of meeting the vehicle driving condition and the demand for generating the electric power.

As above, the hybrid ECU 33 deems that the fuel-consumption improving effect cannot be obtained even when the warm-up operation of the engine 11 is facilitated or that it is not necessary to facilitate the warm-up operation,

when the manual switch 32 is turned ON by the vehicle driver (for example, when the ECO-switch, the canceling switch or the like is turned ON);

when the accelerator opening degree is smaller than the predetermined value (the predetermined degree) and the variation of the accelerator opening degree for the unit time is smaller than the predetermined value (the predetermined variation value); or

when the ambient temperature is lower than the predetermined value (the predetermined temperature) but there is no demand for the heating operation.

In such situation, the hybrid ECU 33 lowers the priority for preferentially carrying out the warm-up operation of the engine 11, so that the adverse effect for the fuel consumption ratio, which may be caused by the process for facilitating the warm-up operation of the engine 11, can be avoided.

In addition, since it is not necessary to use the information from the navigation system or the learning information for the past vehicle driving patterns by the vehicle driver, the control system of the present embodiment can be applied to such a vehicle having no navigation system, to such a case in which the navigation system is not being used (for example, when the destination is not preset in the navigation system), or to such a situation in that the vehicle driver is changed. As a result, it is possible to prevent the adverse effect for the fuel consumption ratio, which may be caused by the process for facilitating the warm-up operation of the engine 11.

In the above embodiment, the priority for facilitating the warm-up operation is lowered by carrying out the preferential control for the MG 12 or the normal control, instead of carrying out the control for facilitating the warm-up operation (including the control for increasing engine rotational speed, the control for retarding ignition timing, the control for increasing output of the engine and so on).

However, a method for lowering the priority for facilitating the warm-up operation should not be limited to the above embodiment. For example, the priority for facilitating the warm-up operation can be lowered by changing control contents for facilitating the warm-up operation (for example, an amount of increasing the engine rotational speed, an amount of retarding the ignition timing, an amount of increasing output of the engine and so on).

In the above embodiment, the routine for controlling the warm-up operation is carried out by the hybrid ECU 33. However, the routine for controlling the warm-up operation can be carried out by other ECUs (for example, the engine ECU, MG-ECU, etc.) or by the hybrid ECU in cooperation with the other ECUs.

The present disclosure should not be limited to the hybrid vehicle shown in FIG. 1 but can be applied to various kinds of the hybrid vehicles, each having the internal combustion and the electric motor generator as the driving source for the vehicle (for example, a hybrid vehicle having multiple motor generators). In addition, the present disclosure can be applied to a so-called PHV type hybrid vehicle (a plug-in hybrid vehicle), according to which a battery of the vehicle can be charged by a power source located on an outside of the vehicle.

What is claimed is:

1. In a control system for a hybrid vehicle, in which an engine and a motor-generator are mounted as a driving source for the hybrid vehicle and a warm-up control unit is provided for facilitating a warm-up operation of the engine when temperature of the engine is low,
the warm-up control unit changes a priority for preferentially carrying out the warm-up operation of the engine in accordance with a predetermined outside request.

2. The control system for the hybrid vehicle according to claim 1, wherein
the warm-up control unit monitors an operation of a warm-up control switch, which corresponds to the predetermined outside request; and
the warm-up control unit raises or lowers the priority for preferentially carrying out the warm-up operation of the engine depending on the operation of the warm-up control switch.

3. The control system for the hybrid vehicle according to claim 1, wherein
the warm-up control unit monitors an accelerator opening degree, which corresponds to the predetermined outside request; and
the warm-up control unit lowers the priority for preferentially carrying out the warm-up operation of the engine, when the accelerator opening degree is smaller than a predetermined opening degree and when a variation of the accelerator opening degree for a unit time is smaller than a predetermined variation value.

4. The control system for the hybrid vehicle according to claim 1, wherein
the warm-up control unit monitors a demand for a heating operation, which corresponds to the predetermined outside request; and
the warm-up control unit lowers the priority for preferentially carrying out the warm-up operation of the engine, when ambient temperature is lower than a predetermined temperature but there exists no demand for the heating operation.

5. The control system for the hybrid vehicle according to claim 1, wherein
the warm-up control unit increases a burden ratio of the motor-generator, which corresponds to a ratio of driving force necessary for driving the vehicle and shouldered by the motor-generator, to a value higher than a predetermined ratio in a normal operation of the vehicle, when a remaining amount of a battery mounted in the vehicle is larger than a predetermined battery amount and temperature of the battery is higher than a predetermined battery temperature.

6. The control system for the hybrid vehicle according to claim 1, wherein
the warm-up control unit preferentially carries out the control for facilitating the warm-up operation of the engine, when a remaining amount of a battery mounted in the vehicle is smaller than a predetermined battery amount or when temperature of the battery is lower than a predetermined battery temperature.

7. In a control system for a hybrid vehicle, in which an engine and a motor-generator are mounted as a driving source for the hybrid vehicle and a warm-up control unit is provided for controlling a warm-up operation of the engine when temperature of the engine is low,
the warm-up control unit preferentially carries out the warm-up operation of the engine when following conditions are satisfied;
a warm-up control switch for canceling a preferential control of the warm-up operation of the engine is turned off;
an accelerator opening degree is larger than a predetermined degree or a variation of the accelerator opening degree for a unit time is larger than a predetermined variation value; and
an ambient temperature is higher than a predetermined temperature or there exists a demand for a heating operation by a heating device.

8. The control system for the hybrid vehicle according to claim 7, wherein
the warm-up control unit carries out the warm-up operation of the engine when a remaining amount of a battery mounted in the vehicle is smaller than a predetermined battery amount or when temperature of the battery is lower than a predetermined battery temperature.

9. The control system for the hybrid vehicle according to claim 7, wherein
the warm-up control unit increases a burden ratio of the motor-generator, which corresponds to a ratio of driving force necessary for driving the vehicle and shouldered by the motor-generator, to a value higher than a predetermined ratio in a normal operation of the vehicle, when a remaining amount of a battery mounted in the vehicle is larger than a predetermined battery amount and temperature of the battery is higher than a predetermined battery temperature.
